(19) United States
(12) Patent Application Publication
(10) Pub. No.: US 2025/0388055 A1
(43) Pub. Date: Dec. 25, 2025

(54) ENHANCED TOW HITCH HAVING A TOW HITCH BUMPER

(71) Applicant: Carl G. Chupron, Taylor, PA (US)

(72) Inventor: Carl G. Chupron, Taylor, PA (US)

(21) Appl. No.: 19/241,870

(22) Filed: Jun. 18, 2025

Related U.S. Application Data
(60) Provisional application No. 63/661,934, filed on Jun. 20, 2024.
(60) Provisional application No. 63/685,887, filed on Aug. 22, 2024.

(51) Int. Cl. B60D 1/36; B60D 1/06; B60D 1/60

(52) U.S. Cl. CPC B60D 1/36; B60D 1/06; B60D 1/60

(57) ABSTRACT

Systems, methods, and other embodiments for a tow hitch having a tow hitch bumper. Decorative plates can be magnetically attached to the tow hitch. Also, a ball-style tow hitch can be equipped with a unique cover or bumper designed to fit perfectly over the ball-style tow hitch. The cover or bumper is configured to maintain protection against damage associated with installing or removing the hitch from a vehicle. Also, the cover or bumper utilizes a ½-inch rubber material that is capable of withstanding inclement weather and offers enough of a barrier to prevent damage to the hitch and the object located on the trailer. Finally, the cover or bumper eliminates the need to pay for expensive repairs associated with tow hitches bumping into an object located on the trailer.

### CROSS-REFERENCE TO RELATED APPLICATION

This application claims benefit of U.S. Patent Application No. 63/661,934, filed on Jun. 20, 2024 and U.S. Patent Application No. 63/685,887, filed on Aug. 22, 2024, the disclosures of which is hereby incorporated by reference in their entirety to provide continuity of disclosure to the extent such disclosures are not inconsistent with the disclosure herein.

### FIELD OF THE INVENTION

The present invention relates to a tow hitch having a tow hitch bumper. In particular, decorative plates can be magnetically attached to the tow hitch. Also, a ball-style tow hitch can be equipped with a unique cover or bumper designed to fit perfectly over the ball-style tow hitch. The cover or bumper is configured to maintain protection against damage associated with installing or removing the hitch from a vehicle. Secondly, the cover or bumper utilizes a ½-inch rubber material that is capable of withstanding inclement weather and offer enough of a barrier to prevent damage to the hitch and the object located on the trailer. Finally, the cover or bumper eliminates the need to pay for expensive repairs associated with tow hitches bumping into an object located on the trailer.

### BACKGROUND OF THE INVENTION

It is known that there tow hitches such as ball-type ball hitches are commonly used to attach a trailer to a vehicle that is used to tow the trailer. A typical tow hitch includes a trailer hitch, a ball mount, a trailer ball, safety chains, and a trailer coupler. If a person wants to transport, for example, a motor boat to a lake, the motor boat needs to be transported on a trailer. Typically, the trailer is equipped with safety chains and a trailer hitch and a trailer coupler attached to the trailer hitch so that the trailer can be easily transported from one location to another location. Also, the vehicle that the person is using to transport the trailer needs to be equipped with a vehicle hitch, a ball mount that can be attached to the vehicle hitch, and a trailer ball that is attached to the ball mount so that the vehicle can be used to easily transport the trailer from one location to another location.

In order to attach the trailer to the vehicle, the vehicle is backed-up so that the trailer ball is aligned with the trailer coupler such that the trailer ball is located at a desired location underneath the trailer coupler. Once the trailer ball has been properly aligned under the trailer coupler, the trailer coupler is conventionally lowered so that an interior of the trailer coupler rests on top of the trailer ball. The trailer coupler is then conventionally locked onto the trailer ball. Also, the safety chains are used to provide another secure attachment between the trailer and the vehicle. Finally, electrical wiring is connected between the trailer and the vehicle to provide power from the vehicle to the trailer to operate lighting on the trailer such as turn signal indicating lighting and back-up lighting.

It is known that during the process of backing up of the vehicle towards the trailer, the trailer ball and/or the ball mount may inadvertently contact the trailer coupler or the object being towed on the trailer such that the trailer ball, trailer coupler and/or object being towed on the trailer may be damaged. Therefore, it would be desirable to provide a cover or bumper over the trailer coupler that would reduce the likelihood of damage occurring when the trailer ball and/or the ball mount inadvertently contacts the trailer coupler and/or the object being towed on the trailer. It would also be desirable to provide the trailer coupler with decorative plates can be magnetically attached to the tow hitch, wherein the decorative plates will assist in properly aligning the trailer ball and/or the ball mount with the trailer coupler.

This invention's purpose is to fulfill these and other needs in the tow hitch art in a manner more apparent to the skilled artisan once given the following disclosure.

The preferred tow hitch and tow hitch cover or bumper, according to various embodiments of the present invention, offers the following advantages: ease of use; reduced likelihood of damage to the trailer ball, trailer coupler, and/or an object being towed on a trailer; portability; low cost; and improved ability to locate the trailer ball and ball mount with respect to the trailer coupler. In many of the preferred embodiments, these advantages are optimized to the extent that is considerably higher than previously achieved in prior known tow hitches.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 is a schematic illustration of a trailer coupler bumper assembly, according to various embodiments of the present invention described herein.

FIG. 1A is a schematic illustration of a trailer coupler bumper assembly being attached to a trailer coupler, according to various embodiments of the present invention described herein.

FIG. 2 is a schematic illustration of the trailer coupler bumper assembly being attached to the trailer coupler, according to various embodiments of the present invention described herein.

FIG. 3 is a schematic illustration of the trailer coupler bumper assembly inadvertently contacting a surface of an object being towed on a trailer, according to various embodiments of the present invention described herein.

FIG. 4 is a schematic illustration of a plurality of decorative plates that can be magnetically attached to the trailer coupler, according to various embodiments of the present invention described herein.

FIG. 5 is a schematic illustration of a trailer coupler being attached to a trailer ball and ball mount, according to various embodiments of the present invention described herein.

FIG. 6 is a schematic view of the plurality of decorative plates located over the trailer coupler, according to various embodiments of the present invention described herein.

FIGS. 7 and 8 are schematic views of the plurality of decorative plates magnetically attached to the trailer coupler, according to various embodiments of the present invention described herein.

### DETAILED DESCRIPTION OF THE INVENTION

The terminology used herein is to describe particular embodiments only and is not intended to be limiting to the invention. As used herein, the term “and/or” includes any and all combinations of one or more of the associated listed items. As used herein, singular forms “a”, “an”, and “the” are intended to include the plural forms as well as the singular forms unless the context clearly indicates otherwise. It will be further understood that the terms “comprises” and/or “comprising,” when used in this specification, specify the presence of stated features, steps, operations, elements, and/or components but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits, and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new enhanced tow hitch having a tow hitch bumper are discussed herein. In the following description, for purposes of explanation, numerous specific details are set forth to provide a thorough understanding of the present invention. It will be evident, however, to one skilled in the art that the present invention may be practiced without these specific details.

The present disclosure is considered an exemplification of the invention and is not intended to limit the invention to the specific embodiments illustrated by the figures or description below.

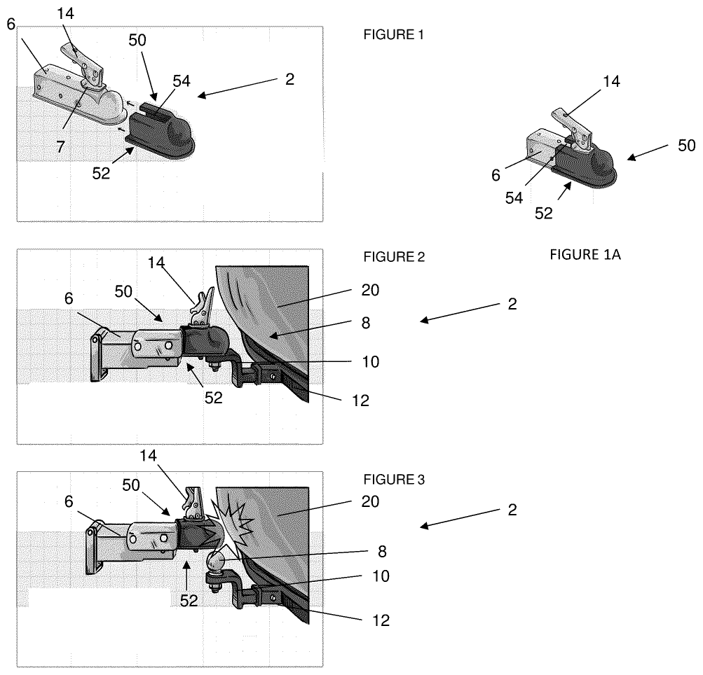

The present invention will now be described by referencing the appended figures representing preferred embodiments. FIGS. 1-3 are illustrations of a tow hitch bumper assembly.

In particular, as shown in FIGS. 1-3, there is illustrated a tow hitch assembly 2. In one embodiment, tow hitch assembly 2 includes, in part, trailer hitch 6, trailer coupler 7, trailer ball 8, ball mount 10, trailer 12, handle 14, towing vehicle 20, and tow hitch bumper assembly 50. It is to be understood that trailer hitch 6 and trailer coupler 7 are typically attached to a vehicle (not shown) that is going to be used to transport a trailer 12. The trailer 12 is typically used to transport the towing vehicle 20 such as a motor boat, a motorcycle, all terrain vehicles (ATVs) or the like. Typically, the trailer 12 is conventionally equipped with a trailer ball 8 and a ball mount 10.

With respect to tow hitch bumper assembly 50, in one embodiment, tow hitch bumper assembly 50 includes, in part, a cover 52 and a slot 54 located along a portion of the top of the cover 52. Preferably, the cover 52 is constructed of any suitable, durable, UV resistant, rust resistant, rubberized material. In one embodiment, the cover 52 should range in thickness from ⅜ inches to ⅝ inches.

Located along a portion of the top of the cover 52 is a slot 54. As will be discussed in greater detail later, the cover 52 is configured with the slot 54 so that the cover 52 is able to slide over the end of the trailer coupler 7 and cover a front portion of the trailer coupler 7.

### Using the Tow Hitch Assembly

In order to use the tow hitch assembly 2, attention is directed to FIGS. 1-3. As shown in FIGS. 1-3, the tow hitch bumper assembly 50 is located in front of the trailer coupler 7 (FIG. 1). The tow hitch bumper assembly 50 is then slid over the front end of the trailer coupler 7 (FIG. 1A).

A unique aspect of the present invention is the use of slot 54. In particular, slot 54 allows the tow hitch bumper assembly 50 to slid past the handle 14 so that the tow hitch bumper assembly 50 can be securely retained on the trailer coupler 7.

Once the tow hitch bumper assembly 50 has been securely retained on the trailer coupler 7, the trailer coupler 7 can be conventionally attached to the trailer ball 8 (FIG. 2).

A unique aspect of the present invention is that if the trailer coupler 7 inadvertently becomes removed from the trailer ball 8, if the trailer coupler 7 contacts the towing vehicle 20, the tow hitch bumper assembly 50 prevents to the trailer coupler 7 from damaging the towing vehicle 20 because the tow hitch bumper assembly 50 acts as an impact barrier between the trailer coupler 7 and the tow hitch bumper assembly 50 (FIG. 3).

### Enhanced Tow Hitch

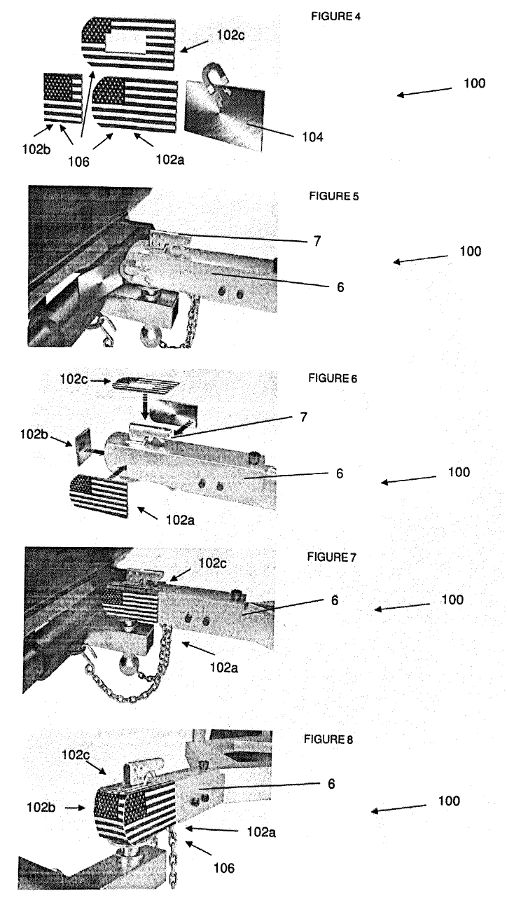

As discussed above, the trailer hitch 6 and trailer coupler 7 can be equipped with a plurality of decorative plates 102a-102c. In another embodiment, the plurality of decorative plates 102a-102c can be part of a tow hitch guidance system 100 which is configured to assist in the attaching of the trailer coupler 7 or the trailer hitch 6 to the trailer ball 8 (FIGS. 1-3). Attention is now directed to FIGS. 4-8, where the decorative palates 102a-102c are illustrated (along with tow hitch guidance system 100).

In particular, decorative plates 102a-102c include decorative indicia 106. Located on the back of each of the plates 102a-102c is a magnetic surface 104. With respect to plates 102a-102c, it is to be understood that plates 102a-102c should be sized and shaped so as to be able to be located on trailer hitch 6. Also, in one embodiment, plates 102a-102c should be constructed of any suitable, durable, high-strength, UV resistant, rust resistant polymeric or metallic material.

With respect to decorative indicia 106, it is to be understood that decorative indicia 106 can include any suitable graphical designs. Also, in one embodiment, the decorative indicia 106 can be constructive from any suitable paint or coating. It is to be further understood that decorative indicia 106 can be constructed with a reflective coating.

In another embodiment, decorative plates 102a-102c can be used in conjunction with tow hitch guidance system 100. As discussed above, plates 102a-102c have decorative indicia 106. Located on the back of each of the plates 102a-102c is a magnetic surface 104.

### Using the Enhanced Tow Hitch

In order to use the enhanced tow hitch, attention is directed to FIGS. 4-8. As shown in FIGS. 4-8, based upon the size and shape of the tow hitch 6, the desired size and shape of the plates 102a-102c can be determined. Once the desired size and shape of the plates 102a-102c have been determined, the desired decorative indicia 106 can be applied to one side of each of the plates 102a-102c (FIG. 4). As discussed above, the other side of each of the plates 102a-102c will include a magnetized surface 104.

After the plates 102a-102c have been constructed with the desired decorative indicia 106, the plates 102a-102c are then secured to the tow hitch 6 as shown in FIGS. 6-8.

In another embodiment, a tow hitch guidance system 100 can be attached to a tow hitch 6. As discussed above, the decorative plates 102a-102c include decorative indicia 106. Located on the back of each of the plates 102a-102c is a magnetic surface 104.

As discussed above, a unique aspect of the present invention is the use of the tow hitch guidance system 100. It is known that during the process of backing up of the vehicle towards the trailer, the trailer ball and/or the ball mount may inadvertently contact the trailer coupler 7 such that the trailer ball 8, trailer coupler 7, and/or towing vehicle 20 (FIGS. 2 and 3) may be damaged. Therefore, it would be desirable to provide the tow hitch 6 with decorative plates 102a-10c can be magnetically attached to the tow hitch 6, wherein the decorative plates 102a-102c will assist in properly aligning the trailer ball 8 and/or the ball mount 10 with the trailer coupler 7 attached to the tow hitch 6. In particular, as the vehicle that is equipped with the ball mount 10 and the trailer ball 8 is backing up towards the tow hitch 6 and the trailer coupler 7, the decorative plates 102a-102c are configured to provide a guide for centering the trailer ball 8 under the trailer coupler 7. Furthermore, if it is dark and the decorative indicia 106 includes a reflective coating, the plates 102a-102c can assist in guiding the trailer ball 8 towards the trailer coupler 7.

It is to be understood that if the user wants to use the decorative plates 102a-102c in conjunction with the tow hitch bumper assembly 50, the decorative plates 102a-102c can be located on the trailer hitch 6 and/or the trailer coupler 7 adjacent to the tow hitch bumper assembly 50 so that the tow hitch bumper assembly 50 does not cover over the decorative plates 102a-102c.

While it has not been mentioned, one familiar with the art would realize that the device is not limited by the materials used to create each apparatus that comprises the invention. Any other material type can comprise some or all of the elements in constructing a tow hitch having a tow hitch bumper in various embodiments of the present invention.

Although the present invention has been illustrated and described herein with reference to preferred embodiments and specific examples, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A trailer hitch system, comprising:
a trailer hitch;
a trailer coupler attached to the trailer hitch; and
a plurality of decorative plates removably connected to the trailer coupler and the trailer hitch.

2. The system, according to claim 1, wherein each of the plurality of decorative plates is further comprised of:
a plate having a first side and a second side;
a decorative indicia located on the first side of the plate; and
a magnetic surface located on the second side of the plate.

3. A trailer hitch bumper system, comprising:
a trailer hitch;
a trailer coupler attached to the trailer hitch; and
a tow hitch bumper assembly located over a portion of the trailer coupler.

4. The system, according to claim 3, wherein the tow hitch bumper assembly is further comprised of:
a cover; and
a slot located along a portion of the top of the cover.

5. The system, according to claim 3, wherein the tow hitch bumper assembly is constructed of a durable, UV resistant, rust resistant, rubberized material.

6. A tow hitch guidance system, comprising:
a trailer hitch;
a trailer coupler attached to the trailer hitch;
a plurality of decorative plates removably connected to the trailer coupler; and
a tow hitch bumper assembly located over a portion of the trailer coupler.

7. The system, according to claim 6, wherein each of the plurality of decorative plates is further comprised of:
a plate having a first side and a second side;
a decorative indicia located on the first side of the plate; and
a magnetic surface located on the second side of the plate.

8. The system, according to claim 7, wherein the magnetic indicia is further comprised of:
a reflective coating.

9. The system, according to claim 6, wherein the tow hitch bumper assembly is further comprised of:
a cover; and
a slot located along a portion of the top of the cover.

10. The system, according to claim 6, wherein the tow hitch bumper assembly is constructed of a durable, UV resistant, rust resistant, rubberized material.
